(19) United States
(12) Patent Application Publication
(10) Pub. No.: US 2025/0131243 A1
(43) Pub. Date: Apr. 24, 2025

(54) Multi-Model Machine Learning Architecture for Media Mix Modeling

(71) Applicant: Expedia, Inc., Seattle, WA (US)

(72) Inventors: Shayan Hassantabar, Seattle, WA (US); Yuling Feng, Bellevue, WA (US); Wenjun Ke, Seattle, WA (US)

(73) Assignee: Expedia, Inc., Seattle, WA (US)

(21) Appl. No.: 18/493,510

(22) Filed: Oct. 24, 2023

(51) Int. Cl. G06N 3/045

(52) U.S. Cl. CPC G06N 3/045

(57) ABSTRACT

In some aspects, the disclosure is directed to a system. The system can include at least one processing circuit comprising at least one memory and one or more processors, the one or more processors configured to obtain interaction data of a media channel, the interaction data comprising timeseries emphasis data; execute a neural network using the interaction data as input to generate a transformed timeseries emphasis data for the media channel, the neural network configured to estimate a shape function; and execute a Bayesian regression model using the transformed timeseries emphasis data for the media channel as input to generate one or more performance variables for the media channel.

### BACKGROUND OF THE DISCLOSURE

In recent years, the media landscape has experienced a transformation, characterized by the proliferation of electronic channels, platforms, and touchpoints through which consumers interact with different brands. This has given rise to the importance of media mix models (MMMs) to help content providers optimize their content emphasis strategies. Implementing a robust MMM, however, presents several technical challenges. For example, it can be difficult to capture and analyze data from an array of diverse sources that each has its own measurement nuances. There is also the challenge of accounting for external factors, like economic fluctuations or competitive actions, which can confound the direct effects of different levels of emphasis. Additionally, the dynamic and real-time nature of some media channels, especially in the digital realm, can necessitate agile model updating and adaptation, which can be processor and memory resource-intensive.

### SUMMARY OF THE DISCLOSURE

In one aspect, the present disclosure describes at least one processing circuit comprising at least one memory and one or more processors, the one or more processors configured to obtain interaction data of a media channel, the interaction data comprising timeseries emphasis data for the media channel; execute a neural network using the interaction data as input to generate transformed timeseries emphasis data for the media channel, the neural network configured to estimate a shape function; and execute a Bayesian regression model using the transformed timeseries emphasis data for the media channel as input to generate one or more performance variables for the media channel. In some embodiments, the one or more processors are further configured to select the neural network for execution from a plurality of respective neural networks stored in the at least one memory responsive to determining the neural network corresponds to the media channel, each of the plurality of respective neural network corresponding to a different media channel.

In some embodiments, the one or more processors are configured to, for each of the plurality of respective neural networks corresponding to respective media channels, execute the respective neural network using interaction data for the respective media channel for a time period to output respective transformed timeseries emphasis data; propagate the respective transformed timeseries emphasis data of each of the respective neural networks into a regression layer to generate a predicted result; and train the neural network based on an actual performance of the media channel during the time period compared to the predicted result.

In some embodiments, the one or more processors are configured to train each of the plurality of respective neural network based on the actual performance of the media channel during the time period compared to the predicted result. In some embodiments, the one or more processors are configured to train the neural network by obtaining an aggregate result based on an actual result for each of the respective media channels for the time period; and training the neural network using a loss function according to a difference between the aggregate result and the predicted result. In some embodiments, the one or more processors are configured to propagate the transformed timeseries emphasis data into a regression layer to generate a predicted result, wherein the one or more processors are configured to train the neural network based on an actual performance of the media channel compared to the predicted result.

In some embodiments, the interaction data is first interaction data, the one or more performance variables are first one or more performance variables, and the one or more processors are further configured to obtain second interaction data associated with the media channel for a time period, the media channel operating based on the transformed timeseries emphasis data for a duration of the time period; execute the neural network using the second interaction data as input to generate second transformed timeseries emphasis data for the media channel; execute the Bayesian regression model using the second transformed timeseries emphasis data for the media channel as an input to generate second one or more performance variables for the media channel; and generate a record comprising an identification of the media channel and the second one or more performance variables. In some embodiments, the one or more processors are further configured to receive the second interaction data from a remote computing device associated with the media channel. In some embodiments, the one or more processors are configured to propagate one or more characteristics into the regression layer in addition to the transformed timeseries emphasis data to generate the predicted result.

In some embodiments, the one or more processors are further configured to simulate operation of the media channel using the shape function of the neural network to generate the interaction data. In some embodiments, the one or more processors are configured to execute the neural network using the interaction data and one or more key performance indicators (KPIs) as input to generate the transformed timeseries emphasis data. In some embodiments, the one or more processors are configured to execute the neural network using the interaction data and one or more seasonality factors as input to generate the transformed timeseries emphasis data.

In another aspect, the present disclosure describes a method. The method may include obtaining, by one or more processing circuits, interaction data of a media channel, the interaction data comprising timeseries emphasis data; executing, by the one or more processing circuits, a neural network using the interaction data as input to generate transformed timeseries emphasis data for the media channel, the neural network configured to estimate a shape function; and executing, by the one or more processing circuits, a Bayesian regression model using the transformed timeseries emphasis data for the media channel as input to generate one or more performance variables for the media channel. In some embodiments, the method further comprises selecting, by the one or more processing circuits, the neural network for execution from a plurality of respective neural networks responsive to determining the neural network corresponds to the media channel, each of the plurality of respective neural network corresponding to a different media channel.

In some embodiments, the method further comprises, for each of the plurality of respective neural networks corresponding to respective media channels, executing, by the one or more processing circuits, the respective neural network using interaction data for the respective media channel for a time period to output respective transformed timeseries emphasis data; propagating, by the one or more processing circuits, the respective transformed timeseries emphasis data of each of the respective neural networks into a regression layer to generate a predicted result; and training, by the one or more processing circuits, the neural network based on an actual performance of the media channel during the time period compared to the predicted result. In some embodiments, the method comprises training, by the one or more processing circuits, each of the plurality of respective neural network based on the actual performance of the media channel during the time period compared to the predicted result. In some embodiments, training the neural network comprises obtaining, by the one or more processing circuits, an aggregate result based on actual interaction data for each of the respective media channels for the time period; and training, by the one or more processing circuits, the neural network using a loss function according to a difference between the aggregate result and the predicted result.

In another aspect, the present disclosure describes one or more non-transitory computer-readable media, the one or more non-transitory computer readable media comprising instructions which, when executed by one or more processors, cause the one or more processors to obtain interaction data of a media channel, the interaction data comprising timeseries emphasis data; execute a neural network using the interaction data as input to generate transformed timeseries emphasis data for the media channel, the neural network configured to estimate a shape function; and execute a Bayesian regression model using the transformed timeseries emphasis data for the media channel as input to generate one or more performance variables for the media channel.

In some embodiments, execution of the instructions causes the one or more processors to select the neural network for execution from a plurality of respective neural networks responsive to determining the neural network corresponds to the media channel, each of the plurality of respective neural network corresponding to a different media channel. In some embodiments, execution of the instructions causes the one or more processors to, for each of the plurality of respective neural networks corresponding to respective media channels, execute the respective neural network using interaction data for the respective media channel for a time period to output respective transformed timeseries emphasis data; and propagate the respective transformed timeseries emphasis data of each of the respective neural networks into a regression layer to generate a predicted result; and train the neural network based on an actual performance of the media channel during the time period compared to the predicted result.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a system for media channel emphasis transformation, according to some implementations;

FIG. 2 is a sequence diagram of an implementation of a system for media channel emphasis transformation, according to some implementations;

FIG. 3 is an illustration of a modular neural network for generating shape transformations for a Bayesian regression model, according to some implementations;

FIG. 4 is a flow chart of a method for media channel emphasis transformation, according to some implementations;

FIG. 5 is a flow chart of a method for media channel emphasis transformation, according to some implementations; and

FIGS. 6A and 6B are block diagrams depicting embodiments of computing devices that can be used in connection with the methods and systems described herein.

The details of various embodiments of the methods and systems are set forth in the accompanying drawings and the description below.

### DETAILED DESCRIPTION

For purposes of reading the description of the various embodiments below, the following descriptions of the sections of the specification and their respective contents may be helpful:
Section A describes embodiments of systems and methods for media channel emphasis transformation; and
Section B describes a computing environment which can be used for practicing embodiments described herein.

### A. Systems and Methods for Media Channel Emphasis Transformation

Media Mix Models (MMM) can be used to estimate how media content emphasis can affect different performance variables of the media content. These models can also be used to improve the allocation of emphasis across media channels to achieve an improved mix of emphasis for improved performance. Other than the emphasis in different media channels, these models can also include external factors such as seasonal components, macroeconomic components, competition, etc. Such external factors can be model control variables. MMMs can be or include regression models that estimate one or more performance variables given the different input variables. The models can be or include a linear regression or a Bayesian model to make use of prior knowledge in estimating model parameters. To model the content saturation and diminishing returns at high emphasis levels, these models can use a curvature function to transform emphasis data of interaction data for a media channel. In one approach, a model can do so by applying the “Hill” function. The Hill function can be a parametric function that provides flexibility through two main hyperparameters, K and S, where S>0 is referred to as slope, while K is referred to as the half-saturation point (since Hill (K)=½ for all s>0).

In some cases, media mix models can consider the lag or carryover effect of content emphasis. The lag or carryover effect can be the portion of the response that occurs in the time periods following the time of emphasis. This effect is achieved by applying another parametric function, which can be referred to as an emphasis decay function (e.g., an adstock function). An emphasis decay function can be implemented as a geometric decay and/or parameterized with a hyperparameter alpha. In conventional approaches, the emphasis decay function and then the shape transformations can be applied to a timeseries set of emphasis data. The output of the emphasis decay function and shape transformation can be fed into a regression model. The Bayesian approach can be used to estimate the posteriors of model parameters using Markov Chain Monte Carlo (MCMC) algorithms.

There are several technical challenges with using fix form functions to model the carryover and shape effects on emphasis levels. For example, as these functions introduce parameters to be improved, this approach can significantly increase the computational cost of the MCMC process to estimate the parameters for each media channel. This problem may only compound in the case of geo-level or hierarchical Bayesian models, where the number of parameters being estimated increases. In another example, setting appropriate priors for the hyperparameters of the shape transformation functions for different media channels can be a cumbersome, time-consuming, and error-prone process. Such difficulties can significantly limit the capability of relying on the models to improve emphasis. Finally, mixing fixed form functions may fail to leverage prior knowledge accumulated from previous or related MMM applications.

A computer implementing the systems and methods described herein can overcome the aforementioned technical deficiencies. For example, the computer can implement neural networks (e.g., deep neural networks) to learn an adaptive set of base functions for Bayesian linear regression. In doing so, the computer can implement at least two components: (i) a modular neural network trained in a data-efficient manner to estimate shape transformations (e.g., transformations in emphasis data) of different media channels, and (ii) a Bayesian regression model that uses the control variables alongside the shape transformation for estimating one or more performance variables (e.g., incremental profit) for the media channels.

In some embodiments, the modular neural network includes at least a set of base functions, one or more modules, and/or a regression layer. The base functions can be configured to generate interaction data for different media channels. The one or more modules can each be or include a neural network with weights and/or parameters to estimate a shape transformation function for a different one of the media channels. The input to a module can be the timeseries of the emphasis decay data for a media channel accounting for a content item's delayed effect and the output can be the transformed emphasis data to model the content saturation and diminishing returns at high emphasis levels. This design can enable the transfer of learned base models from one iteration of the model to the next. This capability can facilitate accounting for knowledge already learned in one or more previous model iterations. The functionality can be useful because the information content available in a single MMM dataset can be low compared to the number of parameters in the model. As a result, the modular neural network component can enable a data-efficient manner to learn adaptive base functions.

Decoupling learning the transformation function from the Bayesian regression can have several advantages. First, doing so can reduce the computational cost of the MCMC process of parameter estimation by more than an order of magnitude. Second, doing so can alleviate the need for the manual process of setting the priors for hill transformation functions.

The second component of the computer can be a Bayesian regression model. The Bayesian regression model may predict one or more performance variables based on control variables and transformed emphasis data. The computer can do so by sampling the posteriors of emphasis data's effects, utilizing information from current data, domain expertise, business insights, and results from incrementality tests. One advantage of implementing the systems and methods described herein is that doing so can provide the ability to reduce the computation cost associated with Markov Chain Monte Carlo (MCMC), which can be used to sample posteriors in the Bayesian regression. The reduction in computation time can facilitate implementing models with more granular data quickly. The flexibility of the modular DNN architecture can unlock three capabilities: to (i) scale up models quickly; (ii) embed more granular information to the modules such as content distribution info, content item's type (display, video) or creative info, etc.; and (iii) implement more complex models such as LSTM and transformer networks to achieve more accurate measurements.

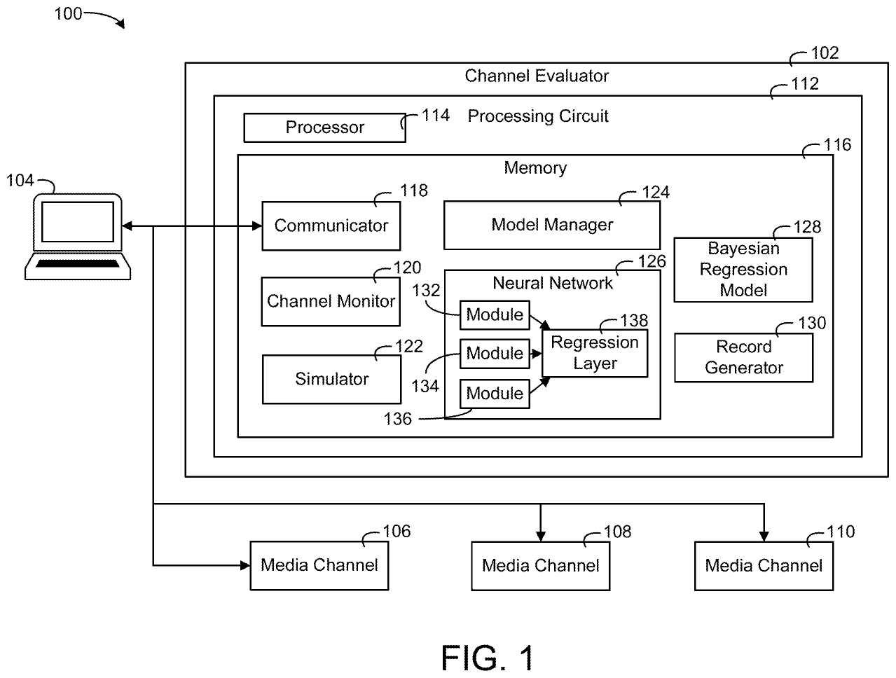

Referring now to FIG. 1, a block diagram of a system 100 for media channel evaluation is shown, according to some implementations. The system 100 may include a channel evaluator 102, a client device 104, and media channels 106, 108, and 110, in some embodiments. The channel evaluator 102 can communicate with the client device 104 and/or the media channels 106, 108, and 110 over a network. The channel evaluator 102 can generate saturation profiles for the media channels 106, 108, and 110. The client device 104 can implement the saturation profiles with the respective media channels 106, 108, and 110. The media channels 106, 108, and 110 can monitor interaction data under the respective individual saturation profiles and transmit the interaction data to the channel evaluator 102. The channel evaluator 102 can execute a modular deep neural network to generate transformed emphasis data for the individual media channels 106, 108, and 110 based on the interaction data for the respective media channels. The channel evaluator 102 can input the transformed emphasis data for the respective media channels 106, 108, and 110 into a Bayesian regression model to generate predicted values for one or more performance variables (e.g., incremental net profit, impressions, uploads, clicks, etc.) for the individual media channels 106, 108, and/or 110 operating according to the respective transformed emphasis data. The channel evaluator 102 can transmit the predicted values to the client device 104 and/or the media channels 106, 108, and/or 110 in a record.

The client device 104 may be or include any type and/or form of media device or computing device, including a desktop computer, laptop computer, portable computer, tablet computer, wearable computer, embedded computer, smart television, set top box, console, Internet of Things (IoT) device or smart appliance, or any other type and form of computing device. Computing device(s) may be referred to variously as a client, device, client device, computing device, anonymized computing device or any other such term. In some cases, the client device 104 can be recording hardware that is not a personal mobile device. Computing devices and intermediary modulators may receive media streams via any appropriate network, including local area networks (LANs), wide area networks (WANs) such as the Internet, satellite networks, cable networks, broadband networks, fiber optic networks, microwave networks, cellular networks, wireless networks, or any combination of these or other such networks. In many implementations, the networks may include a plurality of subnetworks which may be of the same or different types, and may include a plurality of additional devices (not illustrated), including gateways, modems, firewalls, routers, switches, etc. The client device 104 can be a computing device of or associated with a computing system of one or more of the media channels 106, 108, or 110.

The media channels 106, 108, and 110 can be or include specific methods and/or electronic platforms through which content items (e.g., videos, audio segments, or images) can be delivered to different audiences. The media channels 106, 108, and/or 110 can include different types of communication such as television, radio, and printed publications as well as different forms of electronic communication, such as digital and online platforms such as websites, social media platforms, email distributions, and mobile applications. The individual media channels 106, 108, and/or 110 can have unique attributes, audience reach, and/or engagement metrics. The system 100 can include any number of media channels that are in communication with the channel evaluator 102.

The individual media channels 106, 108, and/or 110 can be or include a computing system including one or more computing devices and/or network monitoring devices configured to collect or gather data regarding the media channels 106, 108, and/or 110. In one example, one or more of the media channels 106, 108, and/or 110 can include a computer that monitors interaction data with the respective media channel 106, 108, and/or 110. Examples of such interaction data can include clicks, click-through rates, impressions, conversion rates, viewability, engagement metrics, video metrics (e.g., video views, average view duration, completion rates, interactions like shares or comments, etc.), reach and frequency, bounce rate, page view and/or unique page views, dwell time, cost metrics, referral sources, etc. The interaction data can include emphasis data, which can be or include media spend with a media channel, an amount of content provisioned via the media channel, amount of communication with or through the media channel, etc. The interaction data can include timeseries data with data points indicating amounts of emphasis at individual points in time corresponding to the other types of interaction data, such as impressions or clicks. In one example, the computer can use a pixel on a webpage, a counter that the computer increments individual interactions, or any other monitoring technique to collect one or more types of such interaction data for the media channel 106, 108, and/or 110. The computer can transmit the transaction data to the channel evaluator 102.

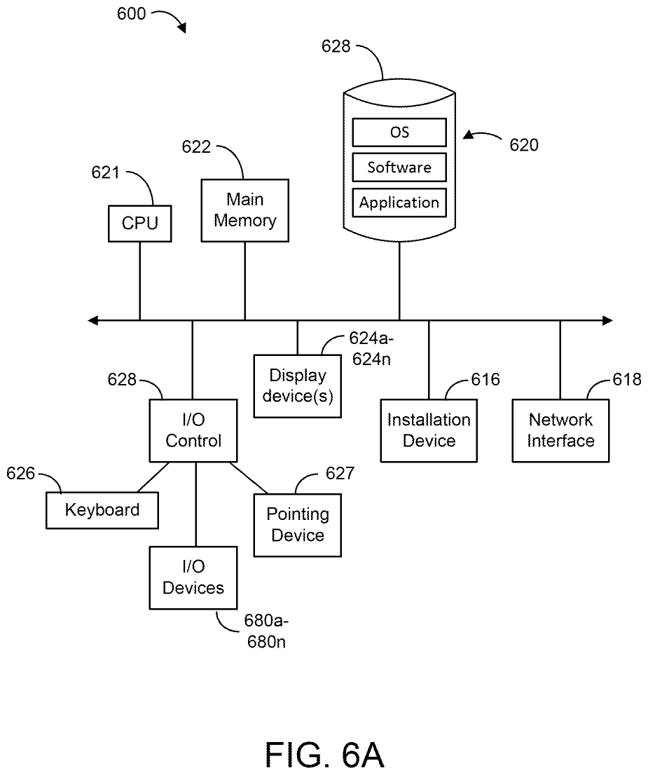

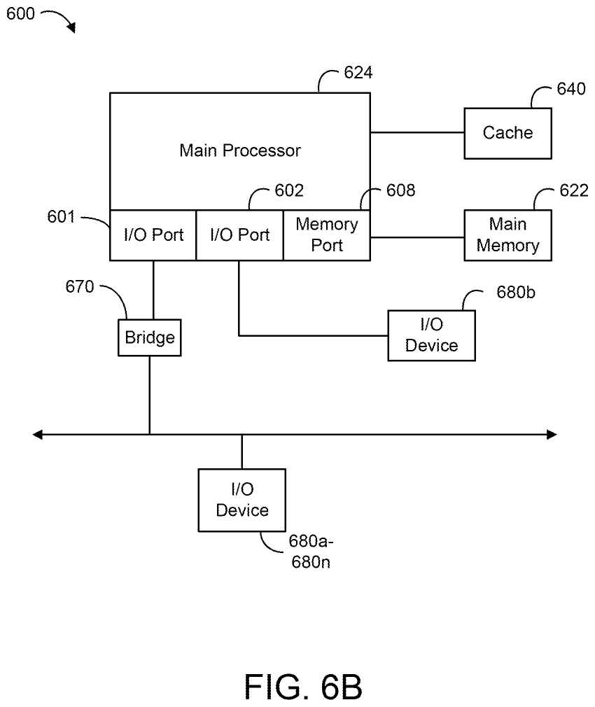

The channel evaluator 102 may include a processing circuit 112, a processor 114, and a memory 116. The processing circuit 112, the processor 114, and/or the memory 116 can correspond to or be the same as components described with reference to FIGS. 6A and 6B. In some embodiments, the channel evaluator 102 can operate in the cloud as one or more cloud servers. The channel evaluator 102 can communicate with the client device 104, computing devices, computing devices of or that are associated with one or more of the media channels 106, 108, and/or 110, and other client devices or computing devices over a network (e.g., a synchronous or asynchronous network).

The memory 116 may include a communicator 118, a channel monitor 120, a simulator 122, a model manager 124, a neural network 126 (e.g., a modular neural network), a Bayesian regression model 128, and/or a record generator 130. The memory 116 may include any number of components. Each of these components may operate to automatically transform emphasis data of different media channels.

The communicator 118 can include instructions performed by one or more servers or processors (e.g., the processing circuit 110), in some embodiments. The communicator 118 may be or include an application programming interface (API) that facilitates communication between the channel evaluator 102 and other computing devices, such as the client device 104 and any computing devices of the media channels 106, 108, and/or 110.

The communicator 118 can establish connections with computing devices (e.g., the client device 104 or computing devices of or associated with the media channels 106, 108, and/or 110). The communicator 118 can establish connections with the computing devices over a network. To do so, the communicator 118 can communicate with the computers across the network. In one example, the communicator 118 can transmit syn packets to the computers (or the computers can transmit syn packets to the communicator 118) and establish the connections using a transport layer security (TLS) handshaking protocol. The communicator 118 can use any handshaking protocol to establish connections with the computers.

The channel monitor 120 can include instructions performed by one or more servers or processors (e.g., the processing circuit 112), in some embodiments. The channel monitor 120 can be configured to collect interaction data from the media channels 106, 108, and/or 110 or from computing devices that are otherwise associated with the media channels 106, 108, and/or 110. The channel monitor 120 can collect the interaction data through the communicator 118. The channel monitor 120 can collect the interaction data over time as the media channels 106, 108, and/or 110 automatically transmit the interaction data to the communicator 118 and/or by polling the computing devices (e.g., remote computing devices) of or associated with the media channels 106, 108, and/or 110 pseudo-randomly or at set intervals.

The simulator 122 can include instructions performed by one or more servers or processors (e.g., the processing circuit 112), in some embodiments. The simulator 122 can be configured to simulate operation of the individual media channels 106, 108, and 110 based on shape functions that correspond to the media channels 106, 108, and 110. For example, the simulator 122 can store or execute a base function for each of the media channels 106, 108, and 110. The base functions can be decay functions, in some embodiments, such as emphasisdecay(t)=mediaemphasis(t)+DecayFactor*emphasisdecay(t−1), or any other function. In the example function, the Decay factor can vary or be the same between the base functions. The simulator 122 can execute the individual base functions for each media channel 106, 108, and 110 to generate interaction data for the respective media channels 106, 108, and 110. The simulator 122 can generate the interaction data for a defined time period, such as by generating data points at set timesteps or defined set time intervals within the defined time period. The simulator 122 can simulate operation of any number of media channels in this way to generate interaction data for the different media channels.

The model manager 124 can include instructions performed by one or more servers or processors (e.g., the processing circuit 112), in some embodiments. The model manager 124 can be configured to operate and/or manage the neural network 126 and/or the Bayesian regression model 128. The model manager 124 can provide inputs into and/or execute the neural network 126 and/or the Bayesian regression model 128. In some embodiments, the model manager 124 can train the neural network 126, such as based on outputs of the neural network 126 and/or data collected by the channel monitor 120, for example.

The neural network 126 can be or include a neural network (e.g., a deep neural network, a modular neural network, or a deep modular neural network) that is configured to output saturation profiles for individual media channels. The neural network 126 can do so based on interaction data of the respective media channels collected by the channel monitor 120 and/or metrics generated by the simulator 122. For example, the neural network 126 can include modules 132, 134, and 136. Each of the modules 132, 134, and 136 can be or include a neural network that corresponds to a specific media channel (e.g., one of the media channels 106, 108, and/or 110). Each of the modules 132, 134, and 136 estimate a base function (e.g., a shape function) for the media channel that corresponds to the module. An example of such a base function can be the Hill function. The modules 132, 134, and 136 can do so by having weights and/or parameters that, together or in combination, represent the respective base functions. The individual modules 132, 134, and 136 can be configured and/or trained to receive data for the media channels corresponding to the respective modules 132, 134, and 136 as input. The model manager 124 can execute the modules 132, 134, and/or 136 that receive the input to cause the modules to implement internal weights and/or parameters on the inputs to output transformed emphasis data for the media channels corresponding to the respective modules 132, 134, and 136.

The model manager 124 can train the modules 132, 134, and 136. The model manager 124 can do so using a regression layer 138 of the neural network 126. The regression layer 138 can include one or more nodes (e.g., activation functions) or be a function itself that is configured to receive one or more of the outputs of the modules 132-136 of the neural network 126. In some embodiments, the outputs from the modules 132-136 can be weighted in the signals to the regression layer. The regression layer 138 can operate to convert the outputs (e.g., the weighted outputs) of the modules 132-136 into a predicted result. The predicted result can be an effect of transformed emphasis data across the different media channels (e.g., across the media channels 106, 108, and/or 110). For instance, the predicted result can be a number of application installs for an application, a number of conversions, a number of impressions, etc. The predicted result can be a numerical value as generated by the regression layer 138 based on the outputs from the modules 132-136 and/or any other number of modules of the neural network 126.

The model manager 124 can train the modules 132, 134, and/or 136 based on the predicted result generated by the regression layer 138 based on outputs from the modules 132, 134, and/or 136. For example, the model manager 124 can execute each of the modules 132, 134, and/or 136 using interaction data generated or obtained for the respective media channels 106, 108, and/or 110 to cause the modules 132, 134, and/or 136 to each generate an output (e.g., transformed emphasis data). The outputs can be propagated, in some cases after weighting, to the regression layer 138. The model manager 124 can execute the regression layer 138 based on the outputs (e.g., the weighted outputs) to generate a predicted result (e.g., a numerical value). The predicted result can be for a defined time period (e.g., a time period into the future or a previous time period). The channel monitor 120 can receive or obtain an actual result (e.g., actual performance) from each of the media channels 106, 108, and/or 110 of the same type operating based on the transformed emphasis data for the time period. For example, if the predicted result is predicted application installs for the time period, the channel monitor 120 can collect or obtain the actual application installs for the time period for the different media channels 106, 108, and/or 110. The model manager 124 can aggregate, determine an average or median, or otherwise combine, the actual results from the media channels 106, 108, and/or 110 to generate an aggregate result. The model manager 124 can compare the aggregate result with the predicted result to determine a difference between the two values using a loss function. The model manager 124 can use backpropagation techniques through the regression layer 138 and/or the modules 132, 134, and/or 136 of the neural network 126 to adjust the weights and/or parameters of the regression layer 138 and/or the modules 132, 134, and/or 136. The model manager 124 can iteratively or repeatedly perform this process over time to train or finetune the modules 132, 134, and/or 136 to accurately estimate saturation profiles or shape functions for the media channels 106, 108, and/or 110 that correspond to the respective modules 132, 134, and/or 136.

In some embodiments, the model manager 124 can add extra parameters as input into the regression layer. The parameters can be or correspond to the current time of year, the length of the time period, the day of the week, the weather, the season, the type of brand associated with the content distribution, etc. The parameters can be control variables that the model manager 124 inputs into the neural network 126 and/or the Bayesian regression model 128. The parameters can be hardcoded or user input values or the model manager 124 can retrieve the user input values from a remote database (e.g., use a pointer associated with the parameter to access a remote or local repository or database containing data for the parameter). The model manager 124 can insert parameters (e.g., values of the parameters) as input into the neural network 126 in the same layer as the output layer of the modules 132, 134, and 136 to cause the parameters to be input (e.g., as a weighted input) into the regression layer 138 with the outputs from the modules 132, 134, and/or 136. The regression layer 138 can generate a predicted result based on the outputs of the modules 132, 134, and/or 136 and the parameters. In some embodiments, the model manager 124 can include a bias (e.g., a hardcoded value) in the inputs to the regression layer 138. The model manager 124 can use backpropagation techniques to train the modules 132, 134, and/or 136 based on the predicted results and actual results (e.g., actual performances) as described herein.

The Bayesian regression model 128 can be or include a Bayesian regression model that is configured to output one or more values for one or more performance variables (e.g., expected profit) based on the transformed emphasis data generated by one or more of the modules 132, 134, or 136 for the media channels 106, 108, and/or 110. The Bayesian regression model 128 can output one or more values for the one or more performance variables for one or more media channels based additionally or instead on one or more control variables. The control variables can be the same as the parameters input into the neural network 126. Other examples of control variables can be or include different key performance indicators (KPIs) (e.g., return on emphasis, incremental, media elasticities, customer lifetime values, etc.), historical sales data, macroeconomic indicators, competitive activity, external events (e.g., natural disasters, strikes, or significant global events), stage in the product life cycle, channel activity, seasonality, etc. The Bayesian regression model 128 can be or include linear regression model such as, for example, performance variable=α+β*(transformed emphasis data), where α and β can be defined values input by a user or determined based on historical data, or any other equation. The equation can include one or more control variables. The defined values can be determined by utilizing information from current data, domain expertise, business insights, and results from incrementality tests, for example. The Bayesian regression model 128 can sample the posteriors of transformed emphasis data's effect to predict a performance variable for one or more media channels based on control variables and transformed emphasis data for the media channel or the one or more media channels, in some embodiments.

The model manager 124 can execute the Bayesian regression model 128 to generate one or more performance variables based on transformed emphasis data generated by the modules 132, 134, and/or 136. In doing so, the Bayesian regression model 128 may have the same control variables and same values for the control variables for each of the modules 132, 134, and/or 136 or the model manager 124 may store and adjust the control variables and/or values for the control variables of the Bayesian regression model 128 based on the media channel for which the Bayesian regression model 128 is generating the one or more performance variables. The model manager 124 can input the transformed emphasis data from one, a subset, or all of the modules 132, 134, and/or 136 into the Bayesian regression model 128 and execute the Bayesian regression model 128. The Bayesian regression model 128 can output one or more performance variables for the one, subset, or all of the modules 132, 134, and/or 136 based on the execution. The model manager 124 can similarly use the Bayesian regression model 128 to generate one or more performance variables for any number of modules or media channels.

The record generator 130 can include instructions performed by one or more servers or processors (e.g., the processing circuit 112), in some embodiments. The record generator 130 can be configured to generate records (e.g., files, documents, tables, listings, messages, notifications, etc.). The record generator 130 can include the data of the records on a user interface that the record generator 130 generates, in some embodiments. For example, the neural network 126 and the Bayesian regression model 128 can generate one or more performance variables for a media channel based on interaction data of the media channel using the systems and methods described herein. The record generator 130 can generate a record including the one or more performance variables. The record generator 130 can transmit the record to the client device 104. The client device 104 can display the data of the record on a user interface to a user. In some embodiments, the channel evaluator 102 can generate one or more performance variables for each of the media channels 106, 108, and 110. In such embodiments, the record generator 130 can include the performance variables and transformed emphasis data for each media channel 106, 108, and 110 in the record.

In some embodiments, the record generator 130 can generate a record containing the transformed emphasis data for the media channels 106, 108, and/or 110 subsequent to the neural network 126 outputting the transformed emphasis data. The record generator 130 can identifications of the media channels 106, 108, and 110 for which the transformed emphasis data was generated. The record generator 130 can transmit the record to the client device 104. The client device 104 can extract the transformed emphasis data from the record. The client device 104 can transmit the transformed emphasis data to the respective media channels 106, 108, and 110 for which the transformed emphasis data was generated. The media channels 106, 108, and 110 can operate according to the transformed emphasis data. The channel evaluator 102 can collect interaction data and/or actual results from the media channels 106, 108, and/or 110 operating based on the transformed emphasis data to use to train the neural network 126 and/or to use as input into the neural network 126 for another transformation process as described herein.

In some embodiments, the neural network 126 and Bayesian regression model 128 can generate one or more performance variables for a media channel responsive to the channel evaluator 102 receiving a request comprising an identification of the media channel from the client device 104. The model manager 124 can identify and select a module 132, 134, or 136 from the neural network 126 that corresponds to the media channel (e.g., has a stored association with an identification of the media channel). The model manager 124 can retrieve interaction data received from the media channel for a defined time period. The model manager 124 can input the retrieved interaction data for the media channel into the selected module 132, 134, or 136. The selected module 132, 134, or 136 can output transformed emphasis data. The model manager 124 can input the transformed emphasis data into the Bayesian regression model 128 and execute the Bayesian regression model 128 to generate one or more performance variables for the media channel. The record generator 130 can generate a record containing the one or more performance variables and transmit the record in a message of one or more data packets to the client device 104. The client device 104 can display one or more performance variables on a user interface.

Continuing with the example, the model manager 124 can train the selected module 132, 134, or 136, in some cases with the other modules 132, 134, and/or 136 of the neural network 126 based on the request. For example, in addition to inserting transformed emphasis added into the Bayesian regression model 128, the model manager 124 can propagate the transformed emphasis data into the regression layer 138. The model manager 124 can also collect interaction data for the other media channels for the time period and execute the modules 132, 134, and/or 136 for the media channels using the respective interaction data as input to generate transformed emphasis data. The model manager 124 can propagate the emphasis added output by each module 132, 134, and/or 136 into the regression layer 138, in some cases with one or more parameters that the regression layer 138 is configured to receive as input. The regression layer 138 can output a value for a predicted result. The result can be a result for the time period of the interaction data or a future time period (e.g., a second time period). The channel monitor 120 can collect data for the actual result from each media channel 106, 108, and 110. The model manager 124 can aggregate the collected data to generate aggregate result data. The model manager 124 can use backpropagation techniques and a loss function to train (e.g., adjust the weights and/or parameters of) the modules 132, 134, and 136 and/or the neural network 126 as a whole based on a difference between the aggregate result data and the predicted result data. Accordingly, the model manager 124 can finetune the modules 132, 134, and/or 136 or the neural network 126 as a whole in real-time. The model manager 124 can similarly train the modules 132, 134, and/or 136 without receiving a request, such as at defined or pseudo-random time intervals.

Subsequent to the training, the channel evaluator 102 can use the neural network 126 and Bayesian regression model 128 again to predict one or more performance variables for the respective media channels 106, 108, and/or 110. For example, the channel monitor 120 can collect interaction data for the media channels 106, 108, and/or 110 for a second time period operating according to the transformed emphasis data output by the modules 132, 134, and/or 136 for the initial time period. The model manager 124 can generate feature vectors with the interaction data for the individual media channels 106, 108, and/or 110 and input the feature vectors into the modules 132, 134, and/or 136 that correspond to the respective media channels 106, 108, and/or 110. In doing so, the model manager 124 can include interaction data only interaction data from the previous time period or include interaction data from any number of previous time periods for which the interaction data was generated, in some embodiments. The modules 132, 134, and/or 136 can generate transformed emphasis data from the interaction data. The model manager 124 can separately input the transformed emphasis data into the Bayesian regression model 128 and execute the Bayesian regression model 128 to generate one or more performance variables for the individual modules 132, 134, and/or 136. The record generator 130 can generate a record including the one or more performance variables, in some cases with stored associations with the media channels 106, 108, and/or 110 for which the one or more performance variables were generated. In some embodiments, the model manager 124 can train the individual modules 132, 134, and/or 136 based on the transformed emphasis data as described herein. The channel evaluator 102 can repeat this process any number of times, accounting for different KPIs and/or seasonality factors that may change between repetitions as well as finetuning the modules 132, 134, and/or 136 over the different repetitions. The channel evaluator 102 can use simulated interaction data for the first iteration but then use real-world collected interaction data over time to generate predicted performance variables for the different media channels.

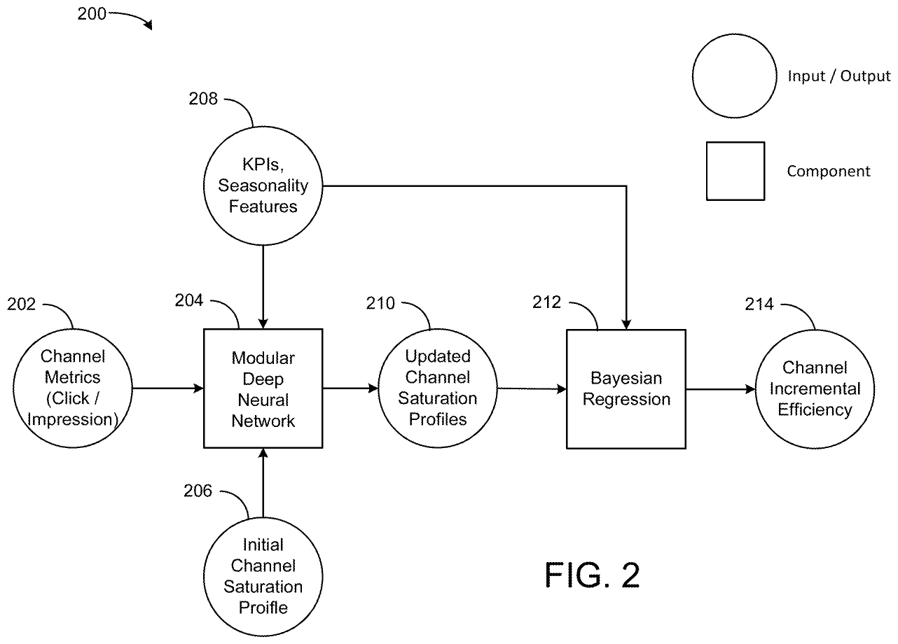

FIG. 2 is a sequence diagram of an implementation of a system for media channel evaluation, according to some implementations. The sequence diagram depicts a sequence 200. The sequence 200 can be performed by components of the system 100. For example, the sequence 200 can be performed by the channel evaluator 102.

In the sequence 200, the data processing system can input interaction data 202 into a modular neural network 204. The interaction data 202 can be interaction data of one or more media channels that the data processing system generated by simulating operation of the one or more media channels according to shape functions 206 (e.g., initial channel saturation profiles) that represent or correspond to the individual media channels. The shape functions 206 can be base shape functions that are configured to generate the interaction data 202 as timeseries datasets, such as for a defined time period or a time period having a defined length of time. The data processing system can input such timeseries datasets of interaction data into the modular neural network 204.

The modular neural network 204 can include one or more neural networks separated into different modules. Each neural network of the modular neural network 204 can include an input layer, one or more hidden layers, and an output layer. The neural networks can be configured to estimate shape functions (e.g., Hill functions) for the different media channels. The data processing system can feed the interaction data 202 generated based on the shape functions 206 into the neural networks that correspond to media channels for which the interaction data 202 was generated.

The data processing system can execute the neural networks to cause the neural networks to output transformed emphasis data. The transformed emphasis data can be or include a timeseries dataset. The data processing system can feed the transformed emphasis data from the different neural networks into a regression layer of the modular neural network 204, in some cases with other parameters. The regression layer can process the different sets of transformed emphasis data, in some cases with the parameters, to output a predicted result. The data processing system can obtain actual result data for the different media channels from the media channels and train the modular neural network 204 (e.g., the individual neural networks of the modular neural network 204) based on the difference between the predicted result and the actual result. In this way, the data processing system can finetune the different neural networks of the modular neural network to estimate updated shape functions (e.g., updated channel saturation profiles).

The data processing system can feed (e.g., separately feed) the transformed emphasis data into a Bayesian regression model 212. The data processing system can execute the Bayesian regression model 212 to output one or more performance variables 214 (e.g., values for one or more performance variables) for the different media channels.

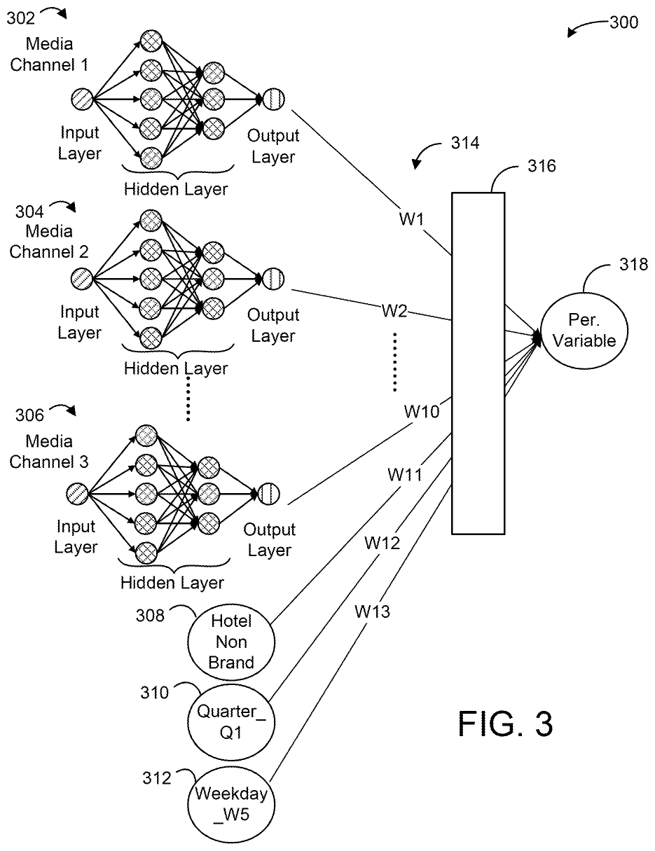

FIG. 3 is an illustration of a modular neural network 300 for generating shape transformations for a Bayesian regression model, according to some implementations. The modular neural network 300 can be the same as or similar to the neural network 126, shown and described with reference to FIG. 1, or the modular neural network 204, shown and described with reference to FIG. 2.

The modular neural network 300 can include neural networks 302, 304, and 306. The neural networks 302, 304, and 306 can be trained or configured to estimate shape functions for different media channels. The neural networks 302, 304, and 306 can do so, for example, based on the internal weights and/or parameters of the respective neural networks 302, 304, and 306. The neural networks 302, 304, and 306 can be configured to receive interaction data for the respective media channels and output transformed emphasis data based on the interaction data. The modular neural network 300 can include neural networks for any number of media channels.

The modular neural network 300 can include parameters 308, 310, and 312. The parameters 308, 310, and 312 can be or represent different input nodes of the modular neural network 300. The parameters 308, 310, and 312 can be input at the same layer of the modular neural network 300 as the output layer of the neural networks 302, 304, and 306, in some embodiments. The parameters 308, 310, and 312 can respectively indicate, for example, the interaction data is for a non-branded hotel, in the first quarter, and during a weekday of week number five. The parameters can be control variables. The modular neural network 300 can include any number of parameters that correspond to the interaction data and/or when the interaction data was received or generated.

The modular neural network 300 can include weights 314. The weights 314 can be in the signals linking the neural networks 302, 304, and 306 and the parameters 308, 310, and 312 with a regression layer 316 of the modular neural network 300. The weights 314 can be individual values (e.g., values within the range of 0 to 1.0) that can operate as multipliers of the values input from the output layers of the neural networks 302, 304, and 306 as well as the parameters 308, 310, and 312. The values can be initialized by a user and updated or adjusted as the modular neural network 300 is trained.

The regression layer 316 can be a layer of one or more nodes or a function. The regression layer 316 can process the weighted values from neural networks 302, 304, and 306 and the parameters 308, 310, and 312 to generate a predicted result 318 (e.g., a number of application installs). In one example, the regression layer 316 can be or include the function:

$$Predicted Result = bias + w 1 * DNN1\_output + w 2 * DNN2\_output + … + w 10 * DNN10\_output + w 11 * control 1 + w 12 * control 2 + w 13 * control 3$$

The predicted result 318 can be an effect of transformed emphasis data across media channels.

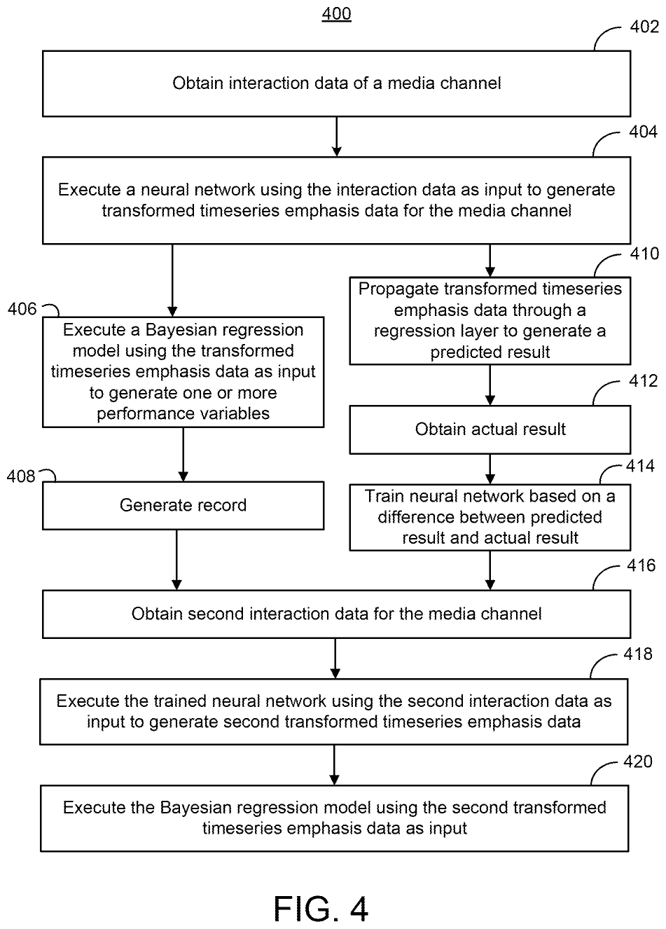

FIG. 4 is a flow chart of a method for media channel evaluation, according to some implementations. The method 400 may be performed by a data processing system (e.g., the channel evaluator 102 or the client device 104, shown and described with reference to FIG. 1, or any other computer or set of computers). The method 400 may include any number of steps and the steps may be performed in any order. The data processing system may perform the method 400 to reduce the processing resources that are required to generate performance data for media channels using Bayesian regression models, replacing shape transformation functions with finetuned neural networks that estimate such shape transformation functions for individual media channels.

At step 402, the data processing system can obtain interaction data of a media channel. The data processing system can obtain the interaction data of the media channel from a remote computing device associated with the media channel, such as a computing device that is a part of the same computer system or computer network as the media channel or a device in communication with the computer network of the media channel. The interaction data can be click data, impression data, emphasis data, etc. of a content distribution being performed on the media channel. The interaction data can be timeseries data including amounts of emphasis for a media channel at different times compared with other types of interactions, such as clicks or impressions. The data processing system can receive the interaction data over time.

In some embodiments, the data processing system can obtain the interaction data by simulating operation of the media channel. The data processing system can do so, for example, by using a shape function configured to represent operation of the media channel. The data processing system can execute the shape function to generate interaction data for the media channel, such as for a defined time period. The data processing system can simulate operation of the media channel to generate the interaction data, for example, as an initial step in performing the method 400.

At step 404, the data processing system can execute a neural network. The neural network can be configured to estimate a shape function. The neural network can be configured to estimate the shape function for the media channel. The data processing system can execute the neural network using the obtained interaction data as input. The neural network can output transformed emphasis data (e.g., transformed timeseries emphasis data) based on the execution.

At step 406, the data processing system can execute a Bayesian regression model. The data processing system can execute the Bayesian regression model using the transformed emphasis data as input. In doing so, the data processing system can execute the Bayesian regression model to cause the Bayesian regression model to generate one or more performance variables. The one or more performance variables can be predicted performance variables for the media channel based on the media channel operating according to the emphasis data.

At step 408, the data processing system can generate a record. The data processing system can generate the record to include the one or more performance variables. In some embodiments, the data processing system can include an identification of the media channel for which the one or more performance variables were generated in the record and/or the transformed emphasis data for the media channel. The data processing system can transmit the record to a client device or a remote computing device, such as a computing device associated with the media channel. The data processing system can transmit the record to the client device or the remote computing device in response to receiving a request from the client device or the remote computing device. In cases in which the data processing system transmits the record to the media channel, the media channel may receive the record including the transformed emphasis data and operate according to the transformed emphasis data.

In some embodiments, in parallel or instead of performing the steps 406 and 408 subsequent to the step 404, the data processing system can perform step 410. At step 410, the data processing system can propagate the transformed timeseries emphasis data through a regression layer. In doing so, the data processing system may cause the regression layer to generate a predicted result. The regression layer may do so, for example, by executing a function on the transformed timeseries emphasis data.

In some embodiments, the neural network may be a module of a modular neural network containing multiple neural networks in different modules. Each of the neural networks or modules can correspond to a different media channel and/or may be configured or trained to estimate a shape function for a different media channel. The data processing system can collect or simulate interaction data for each of the media channels similar to how the data processing system collected or simulated the interaction data in the step 402. The data processing system can input the collected or simulated interaction data for the respective media channels into the neural networks that correspond to the respective media channels and execute the neural networks. Each neural network can generate transformed emphasis data based on the execution. The data processing system can propagate the transformed emphasis data from the different neural networks into the regression layer. In some embodiments, the data processing system can weight the respective transformed emphasis data based on weights (e.g., learned weights). In some embodiments, the data processing system can additionally propagate one or more parameters (e.g., one or more weighted parameters) into the regression layer. The regression layer can output a predicted result (e.g., an effect of the transformed emphasis data, such as a number of application installs) based on the received inputs. The predicted result can be a predicted result for a future time period (e.g., a future time period having a defined length, in some cases starting with the current time).

At step 412, the data processing system can obtain an actual result. The actual result can be the result of different media channels operating according to the transformed emphasis data for the future time period. The data processing system can receive actual result data from each of the media channels. The data processing system can aggregate or perform another function on the actual result data from each media channel to generate aggregate result data.

At step 414, the data processing system can train a neural network. The data processing system can train the neural network based on a difference between the predicted result and the actual result of the transformed emphasis data. In doing so, the data processing system can use the aggregate result data the data processing system generated in step 412. The data processing system can compare the aggregate result data with the predicted result data to determine a difference according to a loss function. The data processing system can use backpropagation techniques to adjust the weights and/or parameters of the modular neural network, including the weights and/or parameters of the individual modules of the modular neural network, according to the difference. In doing so, the data processing system can better finetune the modules to more accurately estimate the shape functions of the media channels to which the modules correspond.

At step 416, the data processing system can obtain second interaction data for the media channel. The data processing system can obtain the second interaction in a similar manner to the manner described with reference to the step 402. The data processing system can obtain the second interaction data for a time period subsequent to the time period in which the data processing obtained interaction of the media channel at step 402. The second interaction data may be generated when the media channel was operating according to the transformed emphasis data generated at the step 404.

At step 418, the data processing system can execute the neural network. The data processing system can execute the neural corresponding to the media channel. The data processing system can execute the neural network using the obtained second interaction data as input. The neural network can output second transformed emphasis data based on the execution.

At step 420, the data processing system can execute the Bayesian regression model. The data processing system can execute the Bayesian regression model using the second transformed timeseries emphasis data as input. In doing so, the data processing system can execute the Bayesian regression model to cause the Bayesian regression model to generate second one or more performance variables for the media channel. The data processing system can generate one or more performance variables for any number of media channels in this manner. In some embodiments, the data processing system can train the neural network based on the second transformed timeseries emphasis data in a similar manner to the manner described with reference to steps 410-414. The data processing system can repeat the method 400 any number of times to continually finetune the modular neural network as well as generate performance variables for the different media channels for different time periods. The media channels can operate according to the transformed emphasis data as the data processing system generates the transformed emphasis data.

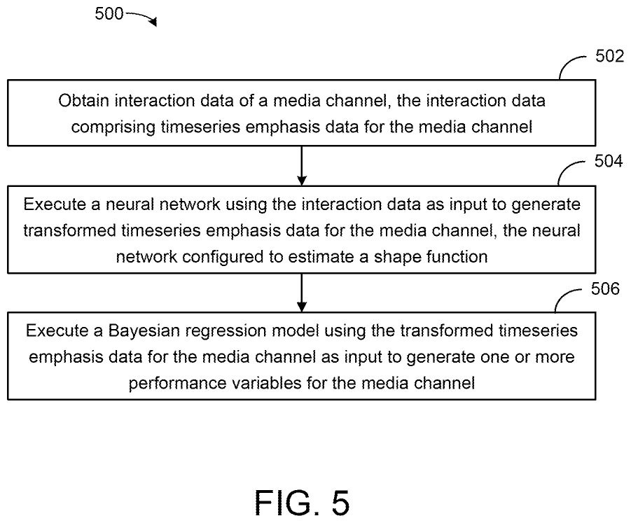

FIG. 5 is a flow chart of a method for dynamic video generation, according to some implementations. The method 500 may be performed by a data processing system (e.g., the channel evaluator 102 or the client device 104, shown and described with reference to FIG. 1, or any other computer or set of computers). The method 500 may include any number of steps and the steps may be performed in any order.

At step 502, the data processing system can obtain interaction data of a media channel, the interaction data comprising timeseries emphasis data for the media channel. At step 504, the data processing system can execute a neural network using the interaction data as input to generate transformed timeseries emphasis data for the media channel, the neural network configured to estimate a shape function. At step 506, the data processing system can execute a Bayesian regression model using the transformed timeseries emphasis data for the media channel as input to generate one or more performance variables for the media channel.

Implementing the systems and methods described herein can offer several technical advantages. For example, a computer implementing the method can replace using a Hill function for emphasis data transformations with a neural network. Doing so can remove the difficulties in determining the parameters of the Hill function to determine the inputs into the Bayesian regression model, which can be a processor and memory-resource intensive process and may not result in accurate determinations even after a large number of attempts. Further, the determinations of parameters for the Hill function may have to be repeated over time as different real-world parameters may change, such as the seasonality and/or other factors that may affect the transformation. The repetitions can be isolated from each other given the nuanced values for the parameters for the different scenarios, which means each determination of parameters can require a large amount of processing resources. The neural network can be constantly trained and finetuned over time to eliminate the processing and memory resources required to determine parameters for the transformation while more accurately approximating the correct transformation function to use for emphasis data transformation to use as input into a Bayesian regression model.

### B. Computing Environment

Having discussed specific embodiments of the present solution, it may be helpful to describe aspects of the operating environment as well as associated system components (e.g., hardware elements) in connection with the methods and systems described herein.

The systems discussed herein may be deployed as and/or executed on any type and form of computing device, such as a computer, network device or appliance capable of communicating on any type and form of network and performing the operations described herein. FIGS. 6A and 6B depict block diagrams of a computing device 600 useful for practicing an embodiment of the systems and methods described herein. As shown in FIGS. 6A and 6B, each computing device 600 includes a central processing unit 621, and a main memory unit 622. As shown in FIG. 6A, a computing device 600 may include a storage device 628, an installation device 616, a network interface 618, an I/O controller 623, display devices 624a-624n, a keyboard 626 and a pointing device 627, such as a mouse. The storage device 628 may include, without limitation, an operating system and/or software. As shown in FIG. 6B, each computing device 600 may also include additional optional elements, such as a memory port 603, a bridge 670, one or more input/output devices 630a-630n (generally referred to using reference numeral 630), and a cache memory 640 in communication with the central processing unit 621.

The central processing unit 621 is any logic circuitry that responds to and processes instructions fetched from the main memory unit 622. In many embodiments, the central processing unit 621 is provided by a microprocessor unit, such as: those manufactured by Intel Corporation of Mountain View, California; those manufactured by International Business Machines of White Plains, New York; or those manufactured by Advanced Micro Devices of Sunnyvale, California. The computing device 600 may be based on any of these processors, or any other processor capable of operating as described herein.

Main memory unit 622 may be one or more memory chips capable of storing data and allowing any storage location to be directly accessed by the microprocessor 621, such as any type or variant of Static random access memory (SRAM), Dynamic random access memory (DRAM), Ferroelectric RAM (FRAM), NAND Flash, NOR Flash and Solid State Drives (SSD). The main memory 622 may be based on any of the above described memory chips, or any other available memory chips capable of operating as described herein. In the embodiment shown in FIG. 6A, the processor 621 communicates with main memory 622 via a system bus 680 (described in more detail below). FIG. 6B depicts an embodiment of a computing device 600 in which the processor communicates directly with main memory 622 via a memory port 603. For example, in FIG. 6B the main memory 622 may be DRDRAM.

FIG. 6B depicts an embodiment in which the main processor 621 communicates directly with cache memory 640 via a secondary bus, sometimes referred to as a backside bus. In other embodiments, the main processor 621 communicates with cache memory 640 using the system bus 680. Cache memory 640 typically has a faster response time than main memory 622 and is provided by, for example, SRAM, BSRAM, or EDRAM. In the embodiment shown in FIG. 6B, the processor 621 communicates with various I/O devices 630 via a local system bus 680. Various buses may be used to connect the central processing unit 621 to any of the I/O devices 630, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 624, the processor 621 may use an Advanced Graphics Port (AGP) to communicate with the display 624. FIG. 6B depicts an embodiment of a computer 600 in which the main processor 621 may communicate directly with I/O device 630b, for example via HYPERTRANSPORT, RAPIDIO, or INFINIBAND communications technology. FIG. 6B also depicts an embodiment in which local busses and direct communication are mixed: the processor 621 communicates with I/O device 630a using a local interconnect bus while communicating with I/O device 630b directly.

A wide variety of I/O devices 630a-630n may be present in the computing device 600. Input devices include keyboards, mice, trackpads, trackballs, microphones, dials, touch pads, touch screens, and drawing tablets. Output devices include video displays, speakers, inkjet printers, laser printers, projectors and dye-sublimation printers. The I/O devices may be controlled by an I/O controller 623 as shown in FIG. 6A. The I/O controller may control one or more I/O devices such as a keyboard 626 and a pointing device 627, e.g., a mouse or optical pen. Furthermore, an I/O device may also provide storage and/or an installation device 616 for the computing device 600. In still other embodiments, the computing device 600 may provide USB connections (not shown) to receive handheld USB storage devices such as the USB Flash Drive line of devices manufactured by Twintech Industry, Inc., of Los Alamitos, California.

Referring again to FIG. 6A, the computing device 600 may support any suitable installation device 616, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 600 may further include a storage device, such as one or more hard disk drives or redundant arrays of independent disks, for storing an operating system and other related software, and for storing application software programs such as any program or software 620 for implementing (e.g., configured and/or designed for) the systems and methods described herein. Optionally, any of the installation devices 616 could also be used as the storage device. Additionally, the operating system and the software can be run from a bootable medium.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 600 communicates with other computing devices 600′ via any type and/or form of gateway or tunneling protocol such as Secure Socket Layer (SSL) or Transport Layer Security (TLS). The network interface 618 may include a built-in network adapter, network interface card, PCMCIA network card, card bus network adapter, wireless network adapter, USB network adapter, modem or any other device suitable for interfacing the computing device 600 to any type of network capable of communication and performing the operations described herein.

In some implementations, the computing device 600 may include or be connected to one or more display devices 624a-624n. As such, any of the I/O devices 630a-630n and/or the I/O controller 623 may include any type and/or form of suitable hardware, software, or combination of hardware and software to support, enable or provide for the connection and use of the display device(s) 624a-624n by the computing device 600. For example, the computing device 600 may include any type and/or form of video adapter, video card, driver, and/or library to interface, communicate, connect or otherwise use the display device(s) 624a-624n. In one embodiment, a video adapter may include multiple connectors to interface to the display device(s) 624a-624n. In other embodiments, the computing device 600 may include multiple video adapters, with each video adapter connected to the display device(s) 624a-624n. In some implementations, any portion of the operating system of the computing device 600 may be configured for using multiple displays 624a-624n. One ordinarily skilled in the art will recognize and appreciate the various ways and embodiments that a computing device 600 may be configured to have one or more display devices 624a-624n.

In further embodiments, an I/O device 630 may be a bridge between the system bus 680 and an external communication bus, such as a USB bus, an Apple Desktop Bus, an RS-232 serial connection, a SCSI bus, a FireWire bus, a FireWire 500 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 600 of the sort depicted in FIGS. 6A and 6B may operate under the control of an operating system, which control scheduling of tasks and access to system resources. The computing device 600 can be running any operating system, such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to, Android, produced by Google Inc.; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others.

The computer system 600 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 600 has sufficient processor power and memory capacity to perform the operations described herein.

In some implementations, the computing device 600 may have different processors, operating systems, and input devices consistent with the device. For example, in one embodiment, the computing device 600 is a smart phone, mobile device, tablet or personal digital assistant. In still other embodiments, the computing device 600 is an Android-based mobile device, an iPhone smart phone manufactured by Apple Computer of Cupertino, California, or a Blackberry or WebOS-based handheld device or smart phone, such as the devices manufactured by Research In Motion Limited. Moreover, the computing device 600 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some implementations, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

What is claimed is:

1. A system, comprising:
at least one processing circuit comprising at least one memory and one or more processors, the one or more processors configured to:
obtain interaction data of a media channel, the interaction data comprising timeseries emphasis data for the media channel;
execute a neural network using the interaction data as input to generate transformed timeseries emphasis data for the media channel, the neural network configured to estimate a shape function; and
execute a Bayesian regression model using the transformed timeseries emphasis data for the media channel as input to generate one or more performance variables for the media channel.

2. The system of claim 1, wherein the one or more processors are further configured to:
select the neural network for execution from a plurality of respective neural networks stored in the at least one memory responsive to determining the neural network corresponds to the media channel, each of the plurality of respective neural network corresponding to a different media channel.

3. The system of claim 2, wherein the one or more processors are configured to:
for each of the plurality of respective neural networks corresponding to respective media channels, execute the respective neural network using interaction data for the respective media channel for a time period to output respective transformed timeseries emphasis data;
propagate the respective transformed timeseries emphasis data of each of the respective neural networks into a regression layer to generate a predicted result; and
train the neural network based on an actual performance of the media channel during the time period compared to the predicted result.

4. The system of claim 3, wherein the one or more processors are configured to train each of the plurality of respective neural network based on the actual performance of the media channel during the time period compared to the predicted result.

5. The system of claim 3, wherein the one or more processors are configured to train the neural network by:
obtaining an aggregate result based on an actual result for each of the respective media channels for the time period; and
training the neural network using a loss function according to a difference between the aggregate result and the predicted result.

6. The system of claim 1, wherein the one or more processors are configured to:
propagate the transformed timeseries emphasis data into a regression layer to generate a predicted result,
wherein the one or more processors are configured to train the neural network based on an actual performance of the media channel compared to the predicted result.

7. The system of claim 6, wherein the interaction data is first interaction data, the one or more performance variables are first one or more performance variables, and the one or more processors are further configured to:
obtain second interaction data associated with the media channel for a time period, the media channel operating based on the transformed timeseries emphasis data for a duration of the time period;
execute the neural network using the second interaction data as input to generate second transformed timeseries emphasis data for the media channel;
execute the Bayesian regression model using the second transformed timeseries emphasis data for the media channel as an input to generate second one or more performance variables for the media channel; and
generate a record comprising an identification of the media channel and the second one or more performance variables.

8. The system of claim 7, wherein the one or more processors are further configured to:
receive the second interaction data from a remote computing device associated with the media channel.

9. The system of claim 6, wherein the one or more processors are configured to:
propagate one or more characteristics into the regression layer in addition to the transformed timeseries emphasis data to generate the predicted result.

10. The system of claim 1, wherein the one or more processors are further configured to:
simulate operation of the media channel using the shape function of the neural network to generate the interaction data.

11. The system of claim 1, wherein the one or more processors are configured to:
execute the neural network using the interaction data and one or more key performance indicators (KPIs) as input to generate the transformed timeseries emphasis data.

12. The system of claim 1, wherein the one or more processors are configured to:
execute the neural network using the interaction data and one or more seasonality factors as input to generate the transformed timeseries emphasis data.

13. A method, comprising:
obtaining, by one or more processing circuits, interaction data of a media channel, the interaction data comprising timeseries emphasis data;
executing, by the one or more processing circuits, a neural network using the interaction data as input to generate transformed timeseries emphasis data for the media channel, the neural network configured to estimate a shape function; and
executing, by the one or more processing circuits, a Bayesian regression model using the transformed timeseries emphasis data for the media channel as input to generate one or more performance variables for the media channel.

14. The method of claim 13, further comprising:
selecting, by the one or more processing circuits, the neural network for execution from a plurality of respective neural networks responsive to determining the neural network corresponds to the media channel, each of the plurality of respective neural network corresponding to a different media channel.

15. The method of claim 14, further comprising:
for each of the plurality of respective neural networks corresponding to respective media channels, executing, by the one or more processing circuits, the respective neural network using interaction data for the respective media channel for a time period to output respective transformed timeseries emphasis data;
propagating, by the one or more processing circuits, the respective transformed timeseries emphasis data of each of the respective neural networks into a regression layer to generate a predicted result; and
training, by the one or more processing circuits, the neural network based on an actual performance of the media channel during the time period compared to the predicted result.

16. The method of claim 15, comprising:
training, by the one or more processing circuits, each of the plurality of respective neural network based on the actual performance of the media channel during the time period compared to the predicted result.

17. The method of claim 15, wherein training the neural network comprises:
obtaining, by the one or more processing circuits, an aggregate result based on actual interaction data for each of the respective media channels for the time period; and
training, by the one or more processing circuits, the neural network using a loss function according to a difference between the aggregate result and the predicted result.

18. One or more non-transitory computer-readable media, the one or more non-transitory computer readable media comprising instructions which, when executed by one or more processors, cause the one or more processors to:
obtain interaction data of a media channel, the interaction data comprising timeseries emphasis data;
execute a neural network using the interaction data as input to generate transformed timeseries emphasis data for the media channel, the neural network configured to estimate a shape function; and
execute a Bayesian regression model using the transformed timeseries emphasis data for the media channel as input to generate one or more performance variables for the media channel.

19. The one or more non-transitory computer-readable media of claim 18, wherein execution of the instructions causes the one or more processors to:
select the neural network for execution from a plurality of respective neural networks responsive to determining the neural network corresponds to the media channel, each of the plurality of respective neural network corresponding to a different media channel.

20. The one or more non-transitory computer-readable media of claim 19, wherein execution of the instructions causes the one or more processors to:
for each of the plurality of respective neural networks corresponding to respective media channels, execute the respective neural network using interaction data for the respective media channel for a time period to output respective transformed timeseries emphasis data; and
propagate the respective transformed timeseries emphasis data of each of the respective neural networks into a regression layer to generate a predicted result; and
train the neural network based on an actual performance of the media channel during the time period compared to the predicted result.
